(19) United States
(12) Patent Application Publication
(10) Pub. No.: US 2026/0210537 A1
(43) Pub. Date: Jul. 23, 2026

(54) SWITCH COVER ASSEMBLIES

(71) Applicants: Garrett Miller, McDonald, TN (US); Jonah Tyree, Ooltewah, TN (US); Arrius Sorbonne, Salt Lake City, UT (US); Benjamin Griffith

(72) Inventors: Garrett Miller, McDonald, TN (US); Jonah Tyree, Ooltewah, TN (US); Arrius Sorbonne, Salt Lake City, UT (US); Benjamin Griffith

(21) Appl. No.: 19/451,749

(22) Filed: Jan. 16, 2026

Related U.S. Application Data
(60) Provisional application No. 63/747,033, filed on Jan. 19, 2025.

(51) Int. Cl. F21V 23/04; F21V 17/06; H01H 9/02

(52) U.S. Cl. CPC F21V 23/0421; F21V 17/06; H01H 9/0242; H01H 2223/044; H01H 2300/024

(57) ABSTRACT

Disclosed are implementations of a switch cover assembly configured to selectively inhibit actuation of at least one switch. The switch cover assembly includes a body and a cover pivotally coupled to the body by a hinge such that the cover is movable between a first position in which access to the at least one switch is inhibited and a second position in which access to the at least one switch is permitted. In some implementations, the hinge includes a spring configured to bias the cover toward the first position or toward the second position, and may include a detent arrangement configured to releasably retain the cover in the first position or the second position. In other implementations, the hinge is a friction hinge configured to resist rotational movement of the cover between the first position and the second position.

### CROSS-REFERENCE TO RELATED APPLICATION(S)

This application claims the benefit of U.S. Provisional Application Ser. No. 63/747,033, filed on Jan. 19, 2025, the entirety of which is incorporated herein by reference.

### TECHNICAL FIELD

This disclosure relates generally to switch accessories and, more particularly, to protective covers for switches of electronic accessories, such as flashlights, remote switches, and laser aiming modules.

### BACKGROUND

Electronic accessories such as flashlights, laser aiming modules, and remote switches often include user-actuatable switches. These switches are routinely used in environments where the electronic accessories are handled frequently, carried, stored in confined spaces, or mounted to other equipment. In these environments, exposed switches can be susceptible to inadvertent actuation by the user and/or by contact with clothing, equipment, or surrounding surfaces. Unintended activation may reduce battery life, cause unwanted light output or other visual signature, or otherwise create operational inconvenience. In some applications, inadvertent actuation may also create safety or tactical concerns.

### SUMMARY

It is to be understood that this summary is not an extensive overview of the disclosure. This summary is exemplary and not restrictive, and it is intended neither to identify key or critical elements of the disclosure nor delineate the scope thereof. The sole purpose of this summary is to explain and exemplify certain concepts of the disclosure as an introduction to the following complete and detailed description.

Disclosed are implementations of a switch cover assembly configured to selectively inhibit actuation of at least one switch. The at least one switch may be part of a flashlight tailcap, a remote switch assembly, or another host device that includes at least one pressure switch. The switch cover assembly includes a body and a cover pivotally coupled to the body by a hinge such that the cover is movable between a first position in which access to the at least one switch is inhibited and a second position in which access to the at least one switch is permitted.

In one example implementation, a switch cover assembly comprises a body, a cover, and a hinge. The body defines an opening that extends between a first end and a second end. The cover is configured to overlie at least a portion of the first end of the opening. The hinge is configured to pivotally couple the cover to the body such that the cover is movable relative to the body between a first position and a second position. The opening is configured to provide access to a switch through the first end, and the cover is configured to inhibit actuation of the switch when in the first position and to permit actuation of the switch when in the second position.

In another example implementation, a switch cover assembly comprises a body, a cover, and a hinge. The body comprises two rail clamps configured for attachment to a rail interface system. The hinge is configured to pivotally couple the cover to the body such that the cover is movable relative to the body between a first position and a second position. A space configured to receive a switch control module is defined between the two rail clamps of the body, and the cover is configured to be positioned over at least a portion of the space defined between the two rail clamps of the body.

In yet another example implementation, a switch cover assembly comprises a body, a cover, and a hinge. The body is configured for attachment to a rail interface system. The hinge is configured to pivotally couple the cover to the body such that the cover is movable relative to the body between a first position and a second position. The body is configured to be positioned adjacent to a remote switch, and the cover is configured to inhibit actuation of a switch of the remote switch when in the first position and to permit actuation of the switch when in the second position.

Any aspect of any implementation may be combined with any one or more aspects of any other implementation(s).

Any one or more of the features disclosed herein.

Any one or more of the features as substantially disclosed herein.

Any one or more of the features as substantially disclosed herein may be combined with any one or more other features as substantially disclosed herein.

Any one of the aspects, features, or implementations may be combined with any one or more other aspects, features, or implementations.

Use of any one or more of the aspects or features disclosed herein.

It should be appreciated that any feature described herein can be claimed in combination with any other feature(s) described herein, regardless of whether the features originate from the same described implementation.

The details of one or more aspects of the disclosure are set forth in the accompanying drawings and the description below. Other features, objects, and advantages of the techniques described in this disclosure will be apparent from the description and drawings, and from the claims.

Numerous additional features and advantages of the present disclosure will become apparent to those skilled in the art upon consideration of the implementation descriptions provided below.

Additional features and advantages are described herein and will be apparent from the following description and figures.

### BRIEF DESCRIPTION OF THE DRAWINGS

FIGS. 1-4 are views of a switch cover assembly in accordance with the principles of the present disclosure secured to a flashlight tailcap.

FIG. 5 is a sectional view of the switch cover assembly and flashlight tailcap taken along line 5-5 shown in FIG. 4.

FIG. 6 is an enlarged view of detail 6 shown in FIG. 5.

FIGS. 7-10 are views of another switch cover assembly in accordance with the principles of the present disclosure secured to a flashlight tailcap.

FIG. 11 is a sectional view of the switch cover assembly and flashlight tailcap taken along line 11-11 shown in FIG. 10.

FIG. 12 is an enlarged view of detail 12 shown in FIG. 11.

FIGS. 13-16 are views of yet another switch cover assembly in accordance with the principles of the present disclosure secured to a flashlight tailcap.

FIG. 17 is a sectional view of the switch cover assembly and flashlight tailcap taken along line 17-17 shown in FIG. 16.

FIG. 18 is an enlarged view of detail 18 shown in FIG. 17.

FIGS. 19-21 are views of still another switch cover assembly in accordance with the principles of the present disclosure secured to a control module of a remote switch.

FIG. 22 is a sectional view of the switch cover assembly and control module taken along line 22-22 shown in FIG. 21.

FIGS. 23-25 are views of yet another switch cover assembly in accordance with the principles of the present disclosure secured to a control module of a remote switch.

FIG. 26 is a sectional view of the switch cover assembly and control module taken along line 26-26 shown in FIG. 25.

FIGS. 27-30 are views of still another switch cover assembly in accordance with the principles of the present disclosure secured to a control module of a remote switch.

FIG. 31 is a sectional view of the switch cover assembly and control module taken along line 31-31 shown in FIG. 30.

FIGS. 32-35 are views of yet another switch cover assembly in accordance with the principles of the present disclosure.

FIG. 36 is a sectional view of the switch cover assembly taken along line 36-36 shown in FIG. 35.

FIG. 37 illustrates still another switch cover assembly in accordance with the principles of the present disclosure.

FIG. 38 illustrates the switch cover assembly shown in FIG. 37 secured to a laser aiming module.

FIGS. 39-40 illustrate additional views of the switch cover assembly shown in FIG. 37.

Like reference numerals refer to corresponding parts throughout the several views of the drawings.

### DETAILED DESCRIPTION

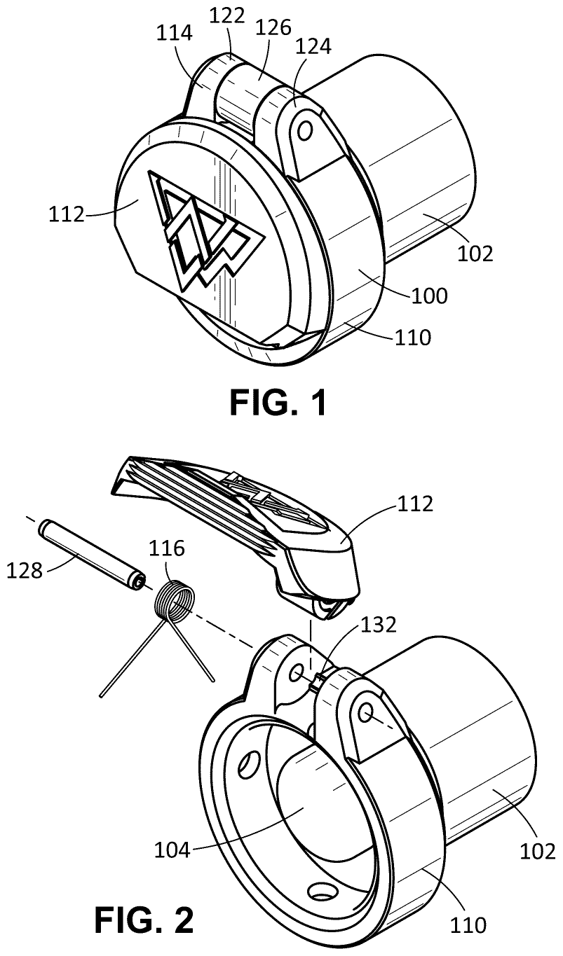

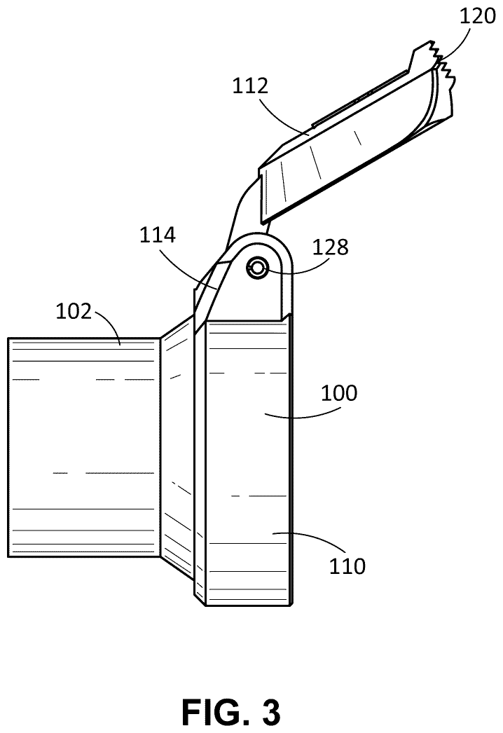

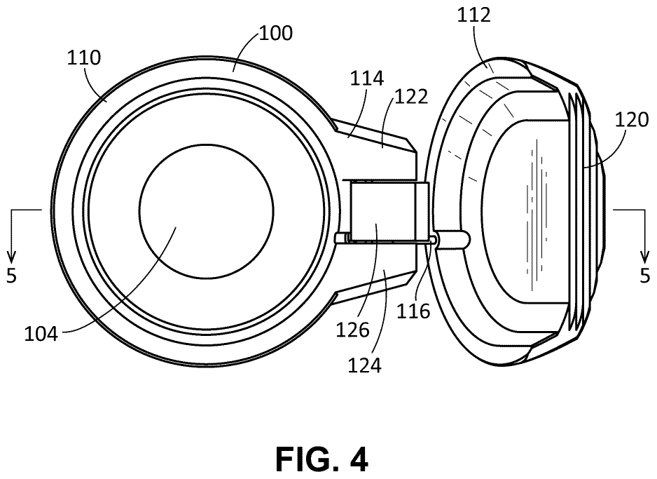

FIGS. 1-6 illustrate a switch cover assembly 100 in accordance with the principles of the present disclosure. The switch cover assembly 100 is attached to a tailcap 102 with a pressure switch 104, the tailcap 102 being configured for attachment to the body of a flashlight. The switch cover assembly 100 is configured to selectively inhibit actuation of the pressure switch 104. In use, the cover 112 can be moved between a first position (closed position), which blocks access to the pressure switch 104 to inhibit actuation (see, e.g., FIG. 1), and a second position (open position), which allows access to the pressure switch 104 for normal operation (see, e.g., FIG. 4).

The switch cover assembly 100 comprises a body 110, a cover 112, and a hinge 114 that pivotally connects the cover 112 to the body 110. The hinge 114 includes a spring 116 configured to bias the cover 112 toward the first position, where the cover 112 prevents accidental activation of the pressure switch 104.

The body 110 is configured for attachment to a flashlight tailcap 102. The body 110 defines an annular opening 118 sized to fit around the end of the tailcap 102, positioning the body 110 adjacent to the pressure switch 104. The annular opening 118 is further configured to provide a friction fit between the body 110 and the tailcap 102.

The cover 112 is configured to shield the pressure switch 104 when positioned over it. The cover 112 is substantially circular in shape, with a planar pad surface 120 formed along a portion of the perimeter. The cover 112 can be operated by pressing the planar pad surface 120 with a fingertip. The planar pad surface 120 may include tactile serrations.

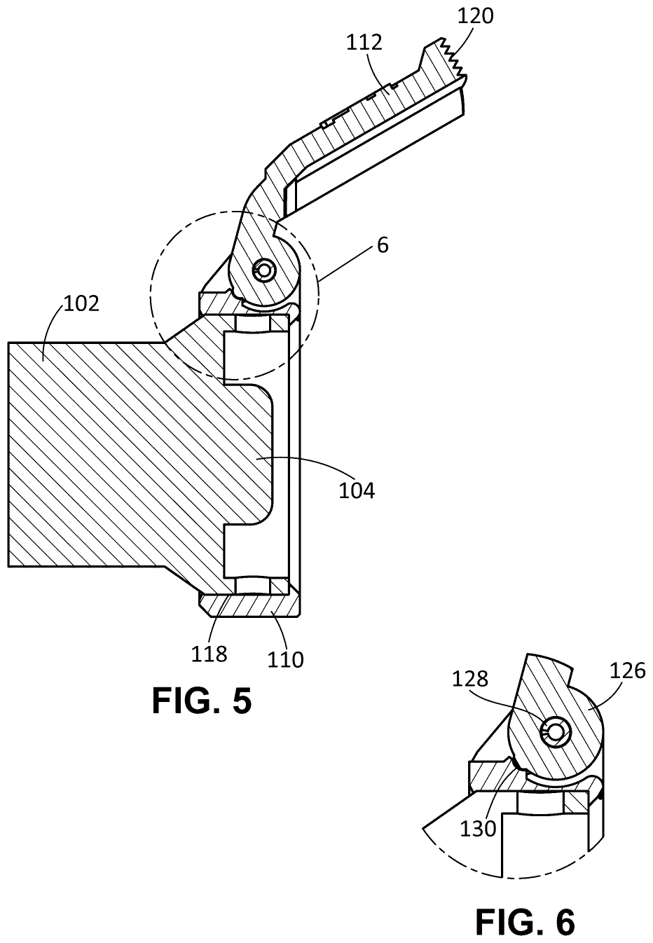

The hinge 114 may be a three-knuckle hinge. Two knuckles 122, 124 are positioned on the body 110, and one knuckle 126 is positioned on the cover 112, opposite the planar pad surface 120. The two knuckles 122, 124 on the body 110 are spaced to receive the knuckle 126 on the cover 112 therebetween. A pin 128 extends through aligned openings in the knuckles 122, 124, 126 and pivotally connects the cover 112 to the body 110, allowing the cover 112 to pivot between the first and second positions. The spring 116 is disposed between two knuckles 124, 126 of the hinge 114 and biases the cover 112 toward the first position (see, e.g., FIG. 4). The spring 116 may be a torsion spring, with one leg seated in an opening in the cover 112 and the other leg seated in an opening in the body 110. The hinge 114 includes a detent 130 configured to releasably secure the cover 112 in the second position (see, e.g., FIGS. 5 and 6), while permitting the cover 112 to be moved out of the second position in response to an applied force. The detent 130 may be a protrusion extending from the knuckle 126 on the cover 112 that engages a groove 132 formed in an intermediate surface positioned between the two knuckles 122, 124 on the body 110. The detent 130 may have a rounded, conical, or rib-shaped profile. The groove 132 may have a complementary profile (e.g., U-shaped, V-shaped, or rectangular) and may include one or more ramped surfaces configured to guide the detent 130 into engagement. In other implementations, the hinge 114 may include a different number of knuckles (e.g., a two-knuckle hinge) and/or be implemented as another type of hinge.

The body 110 and cover 112, including the hinge knuckles (122, 124, 126), may be manufactured via additive manufacturing or injection molding using a polymer material such as nylon 12. The pin 128 may be made of a metal alloy, such as stainless steel.

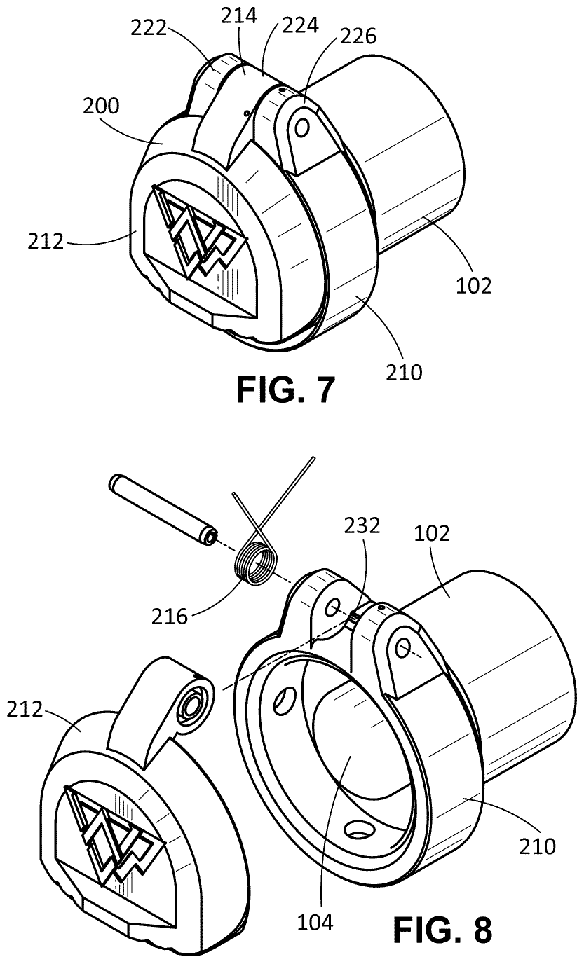

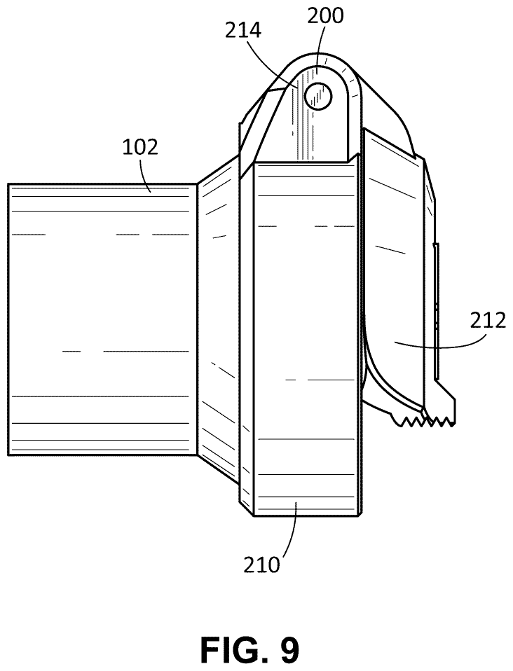

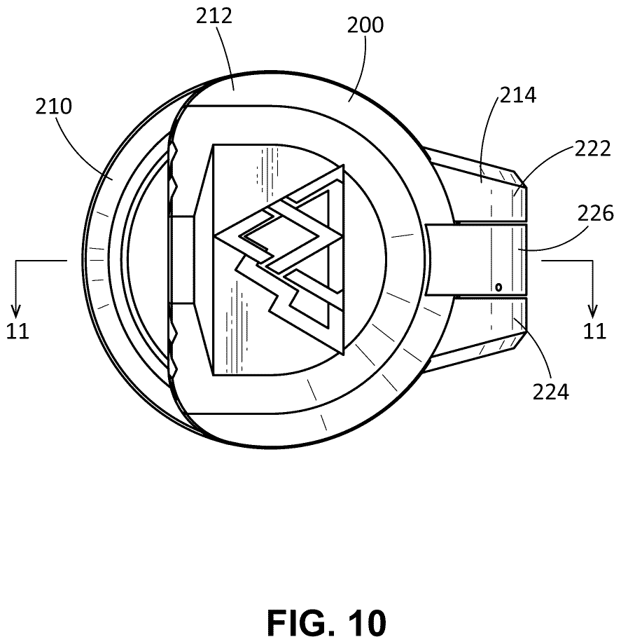

FIGS. 7-12 illustrate another switch cover assembly 200 in accordance with the principles of the present disclosure. The switch cover assembly 200 is similar to the switch cover assembly 100 described above. However, the hinge 214 is configured to bias the cover 212 toward the second position, providing access to the pressure switch 104 for normal operation.

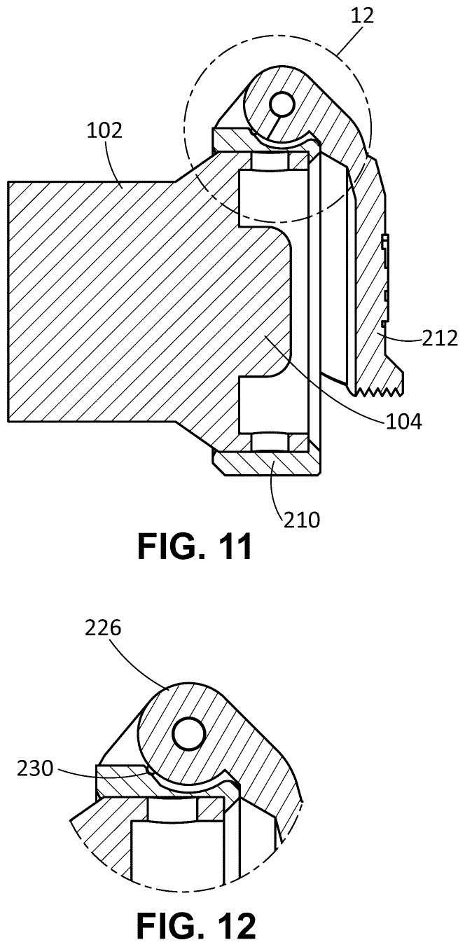

In this implementation, a spring 216 nested between two knuckles 224, 226 of the hinge 214 biases the cover 212 toward the second position. The spring 216 may be a torsion spring, with one leg seated in an opening in the cover 212 and the other leg seated in an opening in the body 210. The hinge 214 includes a detent 230 configured to releasably secure the cover 212 in the first position (see, e.g., FIGS. 11 and 12). The detent 230 is a protrusion extending from the knuckle 226 on the cover 212 that engages a groove 232 formed between the two knuckles 222, 224 on the body 210.

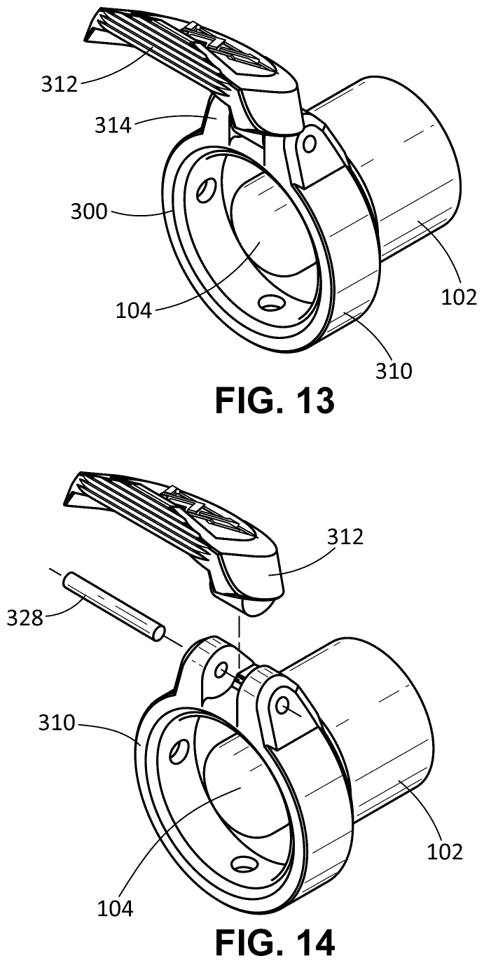

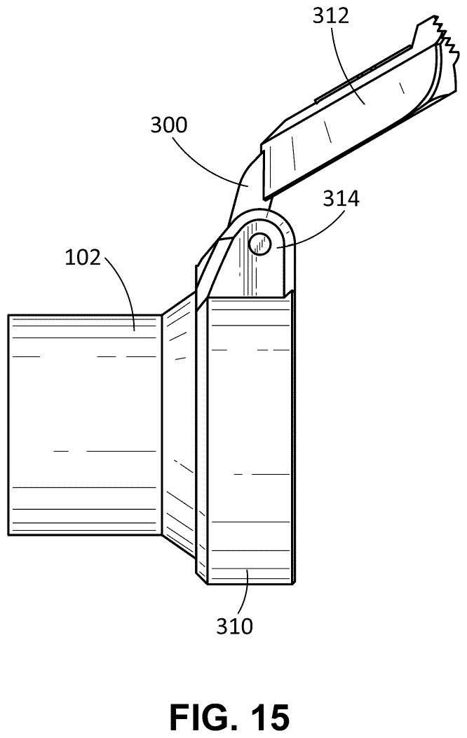

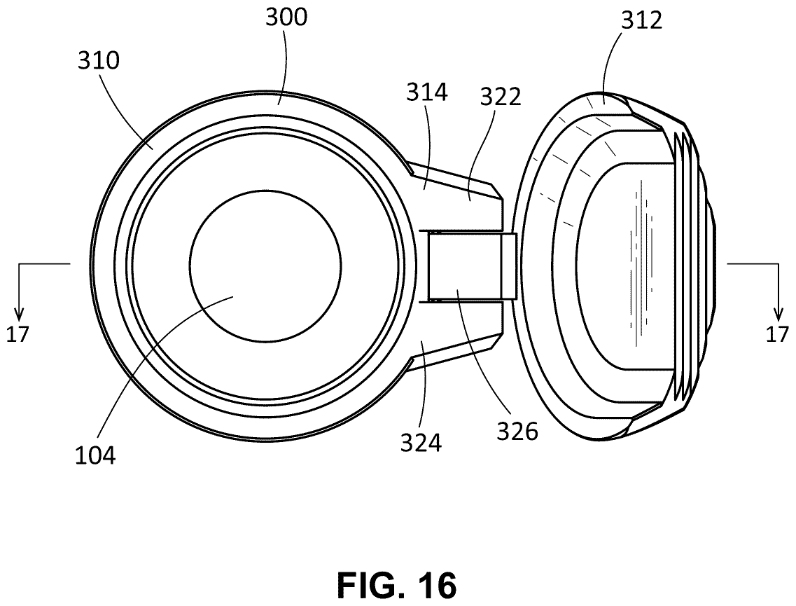

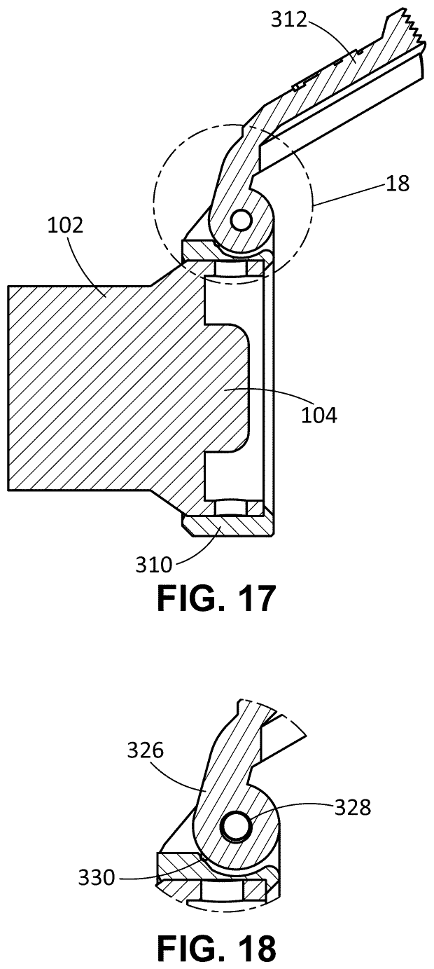

FIGS. 13-18 illustrate yet another switch cover assembly 300 in accordance with the principles of the present disclosure. The switch cover assembly 300 is similar to the switch cover assemblies 100, 200 described above. However, the hinge 314 is a friction hinge configured to be manually rotated between the first and second positions. Friction generated by the hinge 314 resists movement, allowing the cover 312 to remain fixed in the position selected by the user without the need for a spring and/or detent mechanism.

In this implementation, friction is generated between the knuckle 326 of the cover 312 and the pin 328 connecting the cover 312 to the body 310. Additionally, or alternatively, friction may be generated by incorporating a detent 330 on the knuckle 326 of the cover 312, as shown in FIG. 18, and/or by a detent 330 disposed between the knuckles 322, 324 of the body 310, where the detent 330 contacts an opposing surface to create friction that resists relative rotation between the cover 312 and the body 310. The detent 330 may be a protrusion extending from the knuckle 326 on the cover 312. The detent 330 may have a rounded, conical, or rib-shaped profile.

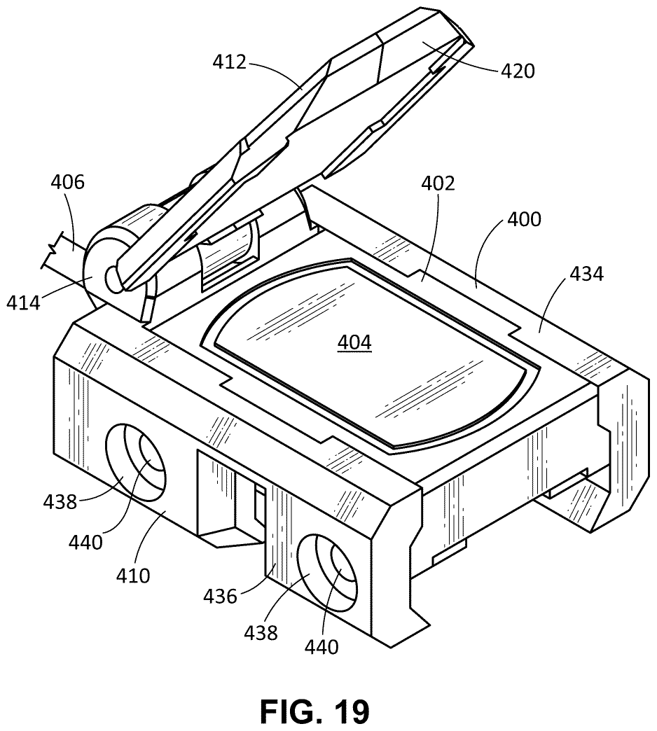

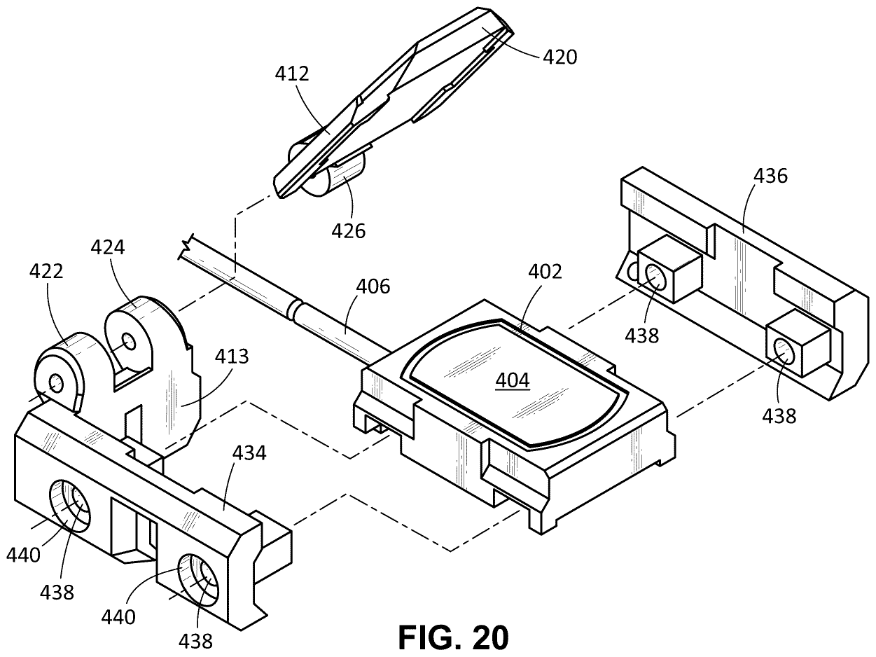

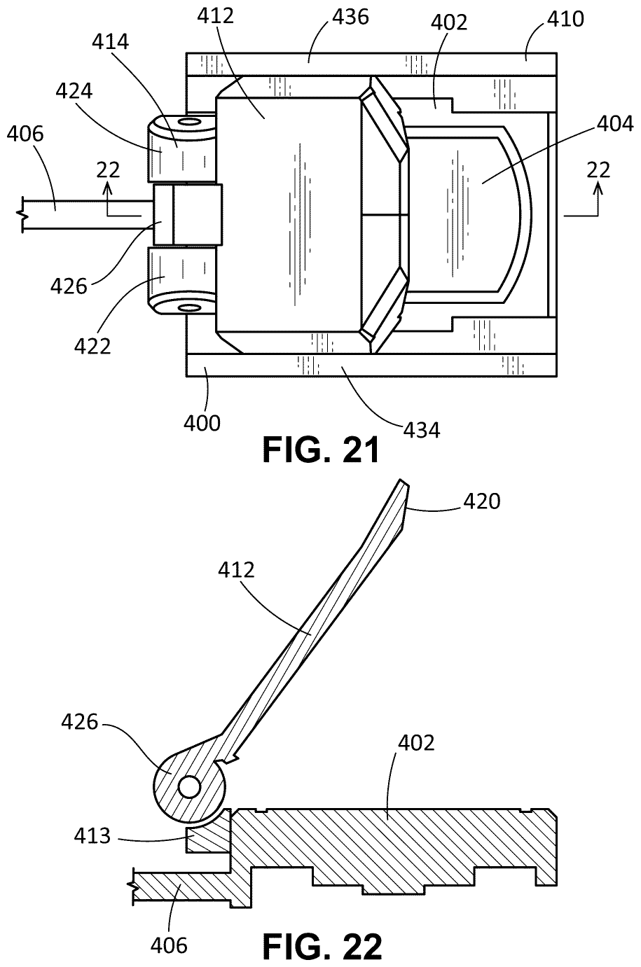

FIGS. 19-22 illustrate still another switch cover assembly 400 in accordance with the principles of the present disclosure. The switch cover assembly 400 is similar to the switch cover assemblies 100, 200, 300 described above. However, the body 410 is configured to attach a control module 402 of a remote switch, such as a ModButton Lite™ switch, to a rail interface system, such as a MIL-STD-1913 Picatinny rail. The example control module 402 includes a momentary-only pressure switch 404, a plug (not shown), and a cable 406 connecting the plug to the pressure switch 404. Although the example control module 402 is from a ModButton Lite™ switch, the switch cover assembly 400 may be configured for use with other control modules of other remote switches.

In this implementation, the body 410 comprises a first rail clamp 434 and a second rail clamp 436. The two rail clamps (434, 436), used in conjunction with two threaded fasteners (e.g., threaded cross bolts), fixedly clamp the control module 402 to a rail interface system. The first and second rail clamps 434, 436 are configured to be positioned on a first lateral side and a second lateral side, respectively, of the control module 402. Each threaded fastener extends laterally through openings 438 in the rail clamps 434, 436. The head of each fastener is seated in a counterbore 440 in one rail clamp 434, and the threaded end extends through the opposite rail clamp 436 and engages a threaded hex nut positioned in a recess. Tightening the threaded fasteners compresses the rail clamps 434, 436 laterally, drawing them together and securely clamping the control module 402 to the rail interface system. The base 413 of the hinge 414 extends laterally from an end of one rail clamp 434 and includes two hinge knuckles 422, 424 spaced to receive the knuckle 426 on the cover 412 therebetween.

As with the switch cover assemblies 100, 200, 300 described above, the cover 412 of the switch cover assembly 400 can be pivoted between a first position (closed position), which covers the pressure switch 404 of the control module 402 to prevent accidental activation, and a second position (open position), which allows access to the pressure switch 404 for normal operation (see, e.g., FIG. 19). Correspondingly, the hinge 414 can be configured to function the same as, or similarly to, the hinges 114, 214, 314 described above and shown in FIGS. 1-17.

The cover 412 is substantially rectangular in shape, with a planar pad surface 420 formed at one end. The planar pad surface 420 is angled relative to the top and bottom surfaces of the cover 412 (see, e.g., FIG. 22). While the example planar pad surface 420 is not textured, one or more of the following textures may be applied to the planar pad surface 420: ribs, grooves, bumps, tactile serrations, or a suitable combination thereof. The cover 412 can be operated by pressing the planar pad surface 420 with a fingertip.

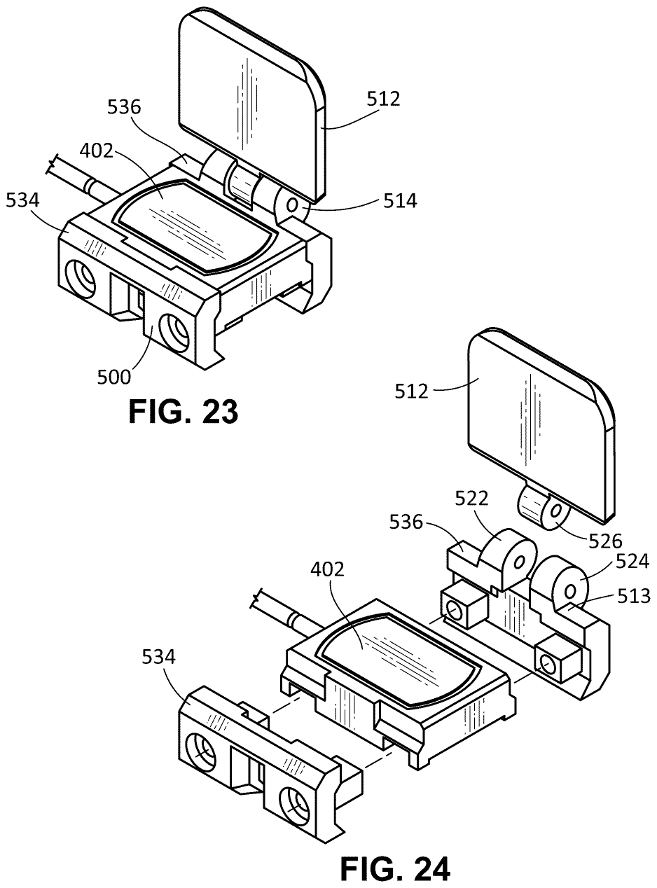

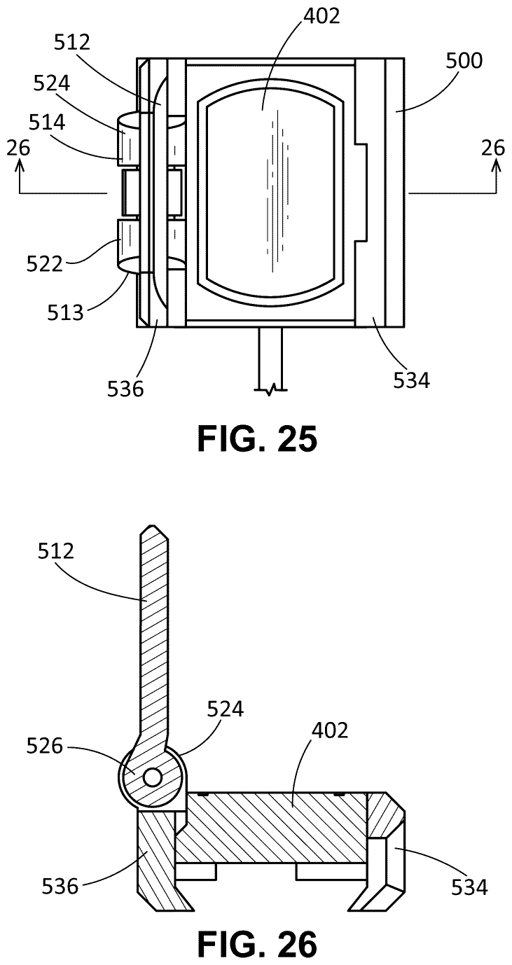

FIGS. 23-26 illustrate yet another switch cover assembly 500 in accordance with the principles of the present disclosure. The switch cover assembly 500 is similar to the switch cover assemblies 100, 200, 300, 400 described above, particularly the switch cover assembly 400 shown in FIGS. 19-22. However, the base 513 of the hinge 514 is integrated into one of the two rail clamps (534, 536), positioning two of the hinge knuckles 522, 524 on a lateral side of the switch control module 402 instead of at the front end or back end. The two hinge knuckles 522, 524 on the rail clamp 536 are spaced to receive the knuckle 526 on the cover 512 therebetween.

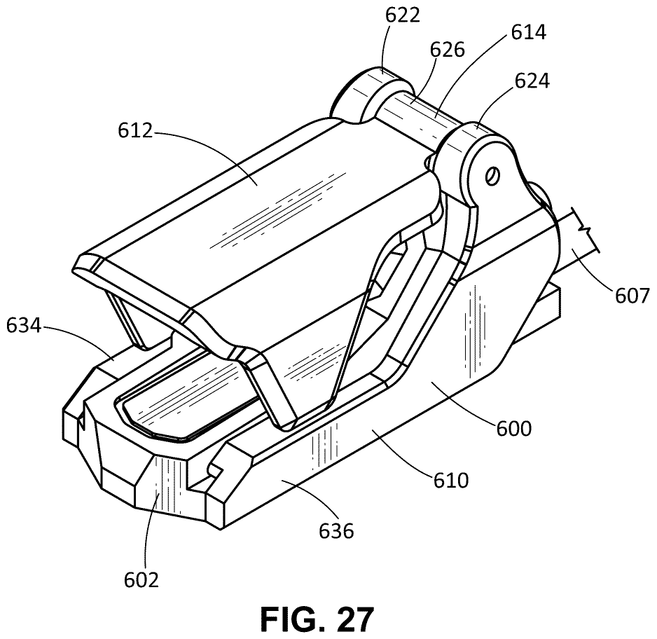

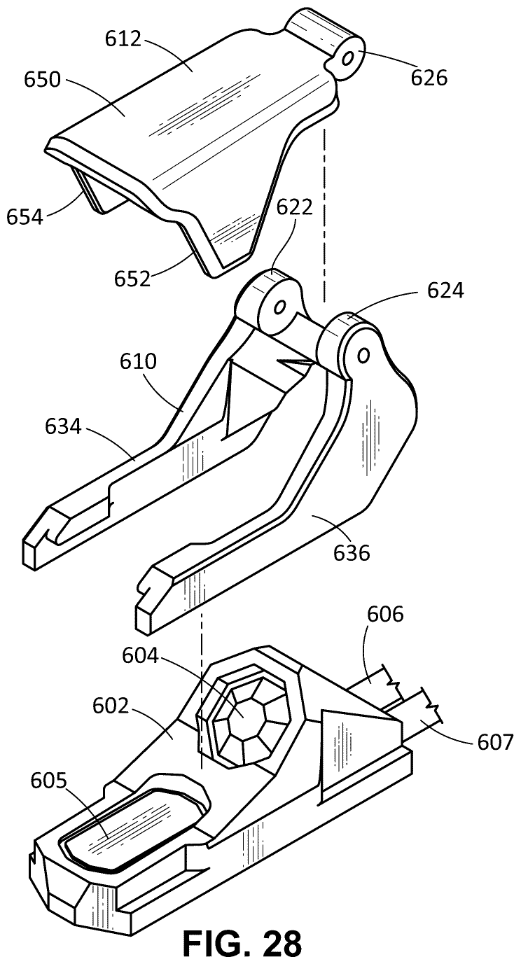

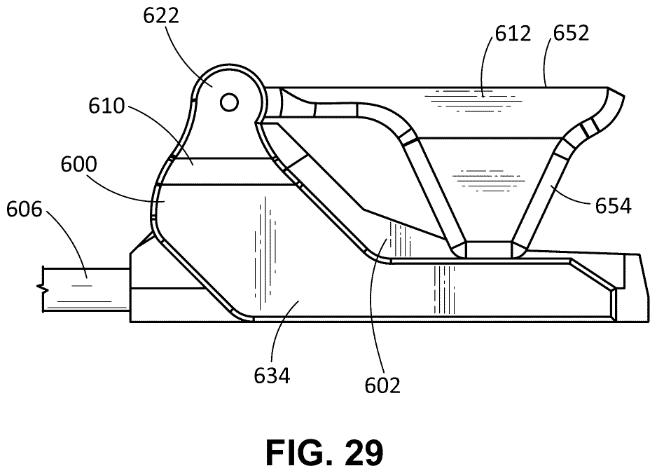

FIGS. 27-31 illustrate still another switch cover assembly 600 in accordance with the principles of the present disclosure. The switch cover assembly 600 is similar to the switch cover assemblies 100, 200, 300, 400, 500 described above. However, the body 610 is configured to attach a control module 602 of a remote switch, such as an AXON™ switch, to a rail interface system, such as a MIL-STD-1913 Picatinny rail. The example control module 602 includes two switches (604, 605), each connected to a plug (not shown) by a flexible cable (606, 607). The first switch 604 has an angled button face and is a pressure-activated switch configured to provide both momentary and constant-on modes of operation. The second switch 605 is a pressure-activated switch configured to provide momentary-only activation. Although the example control module 602 is from an AXON™ switch, the switch cover assembly 600 may be configured for use with other control modules of other remote switches.

In this implementation, the body 610 comprises a first rail clamp 634, a second rail clamp 636, and a hinge base 613 connecting the first and second rail clamps 634, 636. The two rail clamps (634, 636), used in conjunction with two threaded fasteners (e.g., threaded cross bolts), fixedly clamp the control module 602 to a rail interface system. The first and second rail clamps 634, 636 are configured to be positioned on a first lateral side and a second lateral side, respectively, of the control module 602. The hinge base 613 extends between one end of the first rail clamp 634 and one end of the second rail clamp 636, with the two ends being positioned opposite each other when the body 610 is mounted on the control module 602. The hinge base 613 includes two hinge knuckles 622, 624 spaced to receive the knuckle 626 on the cover 612 therebetween. The two hinge knuckles 622, 624 are positioned above the rear end of the control module 602, behind the first switch 604.

Although not shown, each threaded fastener may extend laterally through openings in the rail clamps 634, 636. The head of each fastener is seated in a counterbore in one rail clamp (e.g., 634), and the threaded end extends through the opposite rail clamp (e.g., 636) and engages a threaded hex nut positioned in a recess. Tightening the threaded fasteners compresses the rail clamps 634, 636 laterally, drawing them together and securely clamping the control module 602 to the rail interface system.

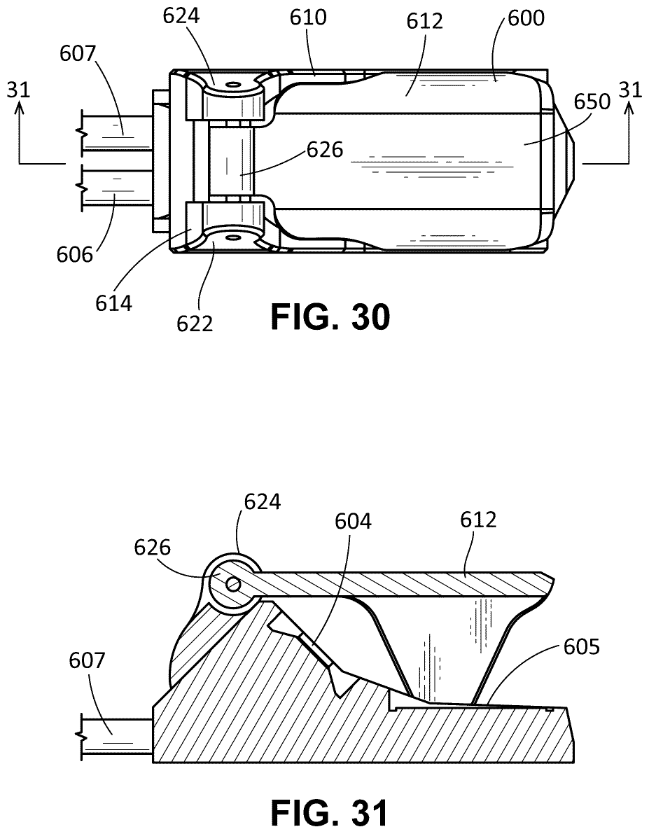

As shown in FIG. 30, the cover 612 is configured to shield both switches 604, 605 when positioned over them. The cover 612 includes a top wall 650 and first and second side walls 652, 654 that extend downwardly from opposing lateral edges of the top wall 650. As with the switch cover assemblies 100, 200, 300, 400, 500 described above, the cover 612 of the switch cover assembly 600 is pivotable between a first position (closed position), which covers both switches 604, 605 of the control module 602 to prevent accidental activation, and a second position (open position), which allows access to both switches 604, 605 for normal operation. Correspondingly, the hinge 614 can be configured to function the same as, or similarly to, the hinges 114, 214, 314 described above and shown in FIGS. 1-17.

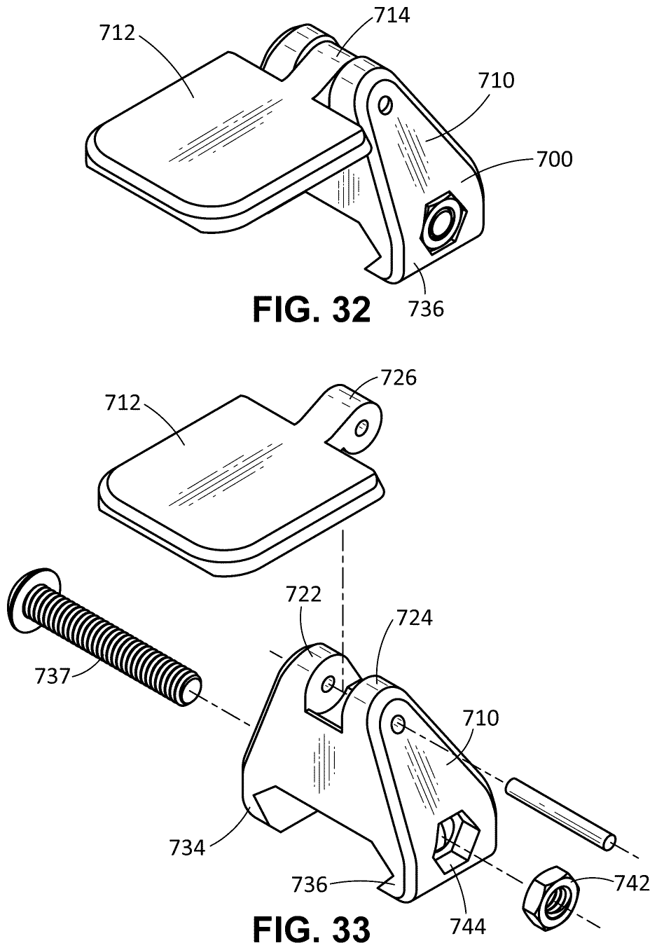

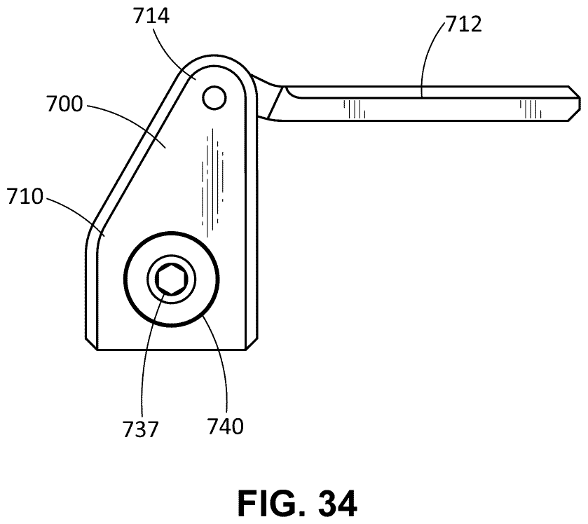

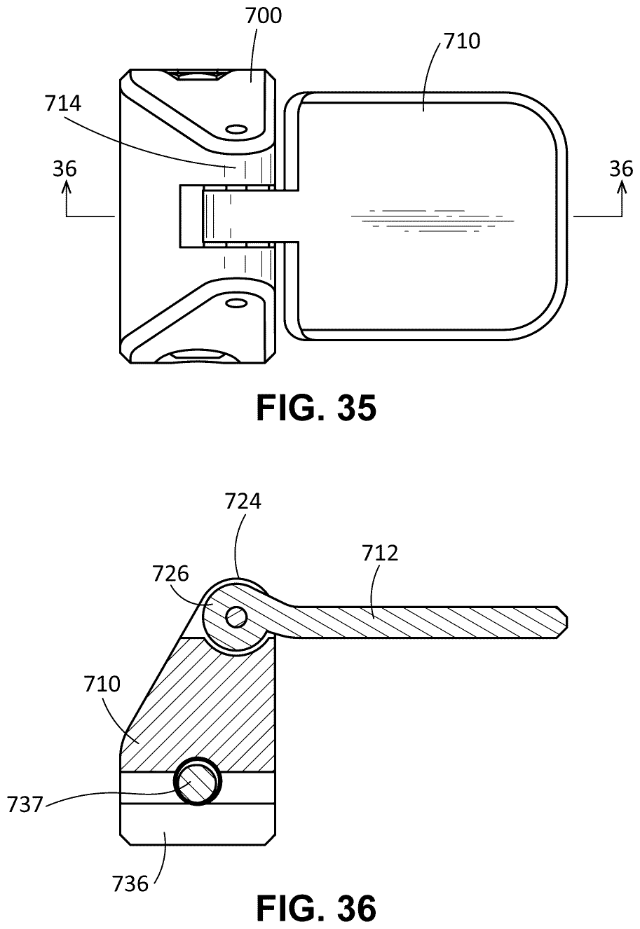

FIGS. 32-36 illustrate yet another switch cover assembly 700 in accordance with the principles of the present disclosure. The switch cover assembly 700 is similar to the switch cover assemblies 100, 200, 300, 400, 500, 600 described above. However, the body 710 is configured for direct attachment to a rail interface system, such as a MIL-STD-1913 Picatinny rail, and to selectively position the cover 712 over a properly positioned switch, such as a pressure switch of a remote switch (e.g., a ModButton Lite™ switch). Although the example remote switch is a ModButton Lite™ switch, the switch cover assembly 700 may be configured for use with other remote switches.

In this implementation, the base of the body 710 includes a first rail clamp 734 and a second rail clamp 736. The rail clamps (734, 736), used in conjunction with a threaded fastener 737 (e.g., a threaded cross bolt), fixedly secure the switch cover assembly 700 to a rail interface system. The threaded fastener 737 extends laterally through openings in the rail clamps 734, 736. The head of the fastener 737 is seated in a counterbore 740 in one rail clamp 734, and the threaded end extends through the opposite rail clamp and engages a threaded hex nut 742 positioned in a recess 744. Tightening the threaded fastener 737 compresses the rail clamps 734, 736 laterally, drawing them together and securely clamping the switch cover assembly 700 to the rail interface system. The body 710 also includes two hinge knuckles 722, 724 spaced to receive the knuckle 726 on the cover 712 therebetween. The knuckles (722, 724, 726) are positioned over the rail clamps 734, 736.

The cover 712 is configured to shield an underlying pressure switch when positioned over it. In some implementations, the cover 712 may be configured to shield two or more switches. The cover 712 is substantially rectangular in shape, and may include a planar pad surface formed at one end. As with the switch cover assemblies 100, 200, 300, 400, 500, 600 described above, the cover 712 of the switch cover assembly 700 can be pivoted between a first position (closed position), which shields an underlying pressure switch to prevent accidental activation, and a second position (open position), which allows access to the pressure switch for normal operation. Correspondingly, the hinge 714 can be configured to function the same as, or similarly to, the hinges 114, 214, 314 described above and shown in FIGS. 1-17.

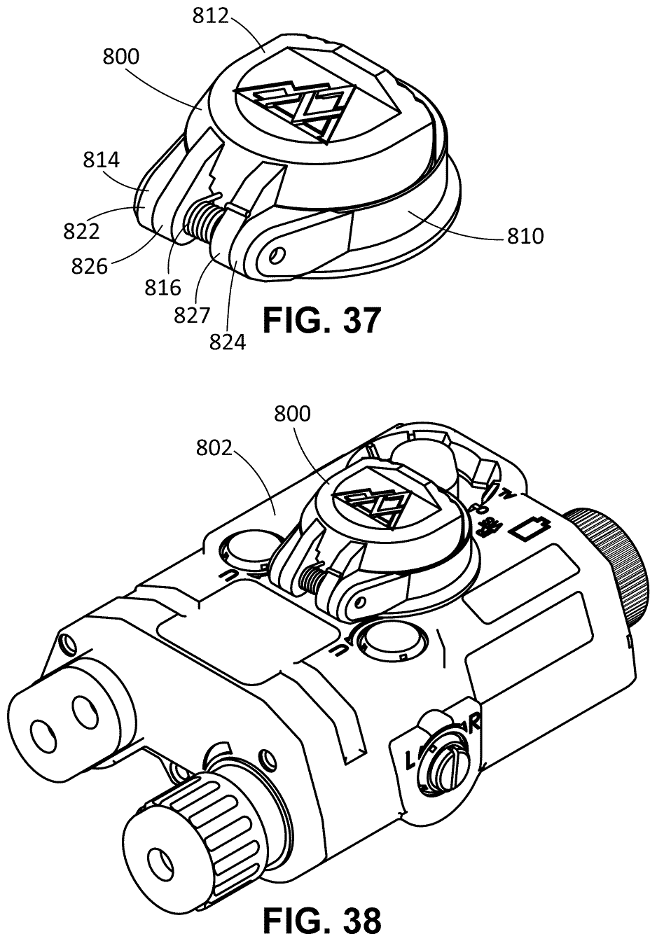

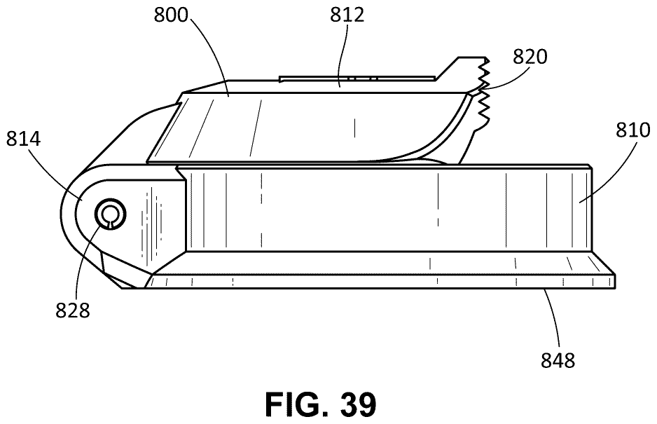

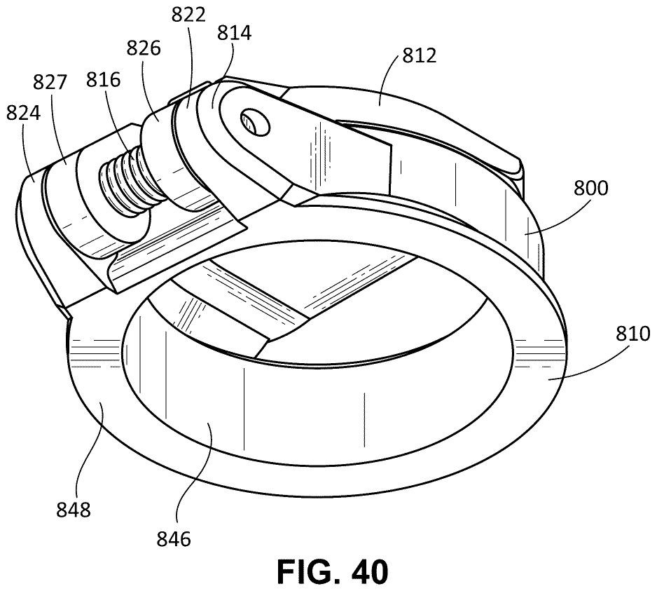

FIGS. 37-40 illustrate still another switch cover assembly 800 in accordance with the principles of the present disclosure. The switch cover assembly 800 is similar to the switch cover assemblies 100, 200, 300, 400, 500, 600, 700 described above, particularly the switch cover assemblies 100, 200, 300 shown in FIGS. 1-17. However, the body 810 is configured for attachment to a laser aiming module 802.

In this implementation, the body 810 defines an annular opening 846 sized to provide access to the fire switch of the laser aiming module 802. The bottom surface of the body 810 includes an annular lip 848 that can receive adhesive used to secure the body 810 to the laser aiming module 802, such as an AN/PEQ-15 or other multi-function aiming laser (MFAL). The annular lip 848 may be configured to seat against a selected attachment area of the laser aiming module 802.

As with the switch cover assemblies 100, 200, 300 described above, the cover 812 of the switch cover assembly 800 can be pivoted between a first position (closed position), which covers the fire switch to prevent accidental activation (see, e.g., FIG. 38), and a second position (open position), which allows access to the fire switch for normal operation.

The hinge 814 of the switch cover assembly 800 can be configured to function the same as, or similarly to, the hinges 114, 214, 314 described above and shown in FIGS. 1-17. In some implementations, the hinge 814 may be a four-knuckle hinge. Two knuckles 822, 824 are positioned on the body 810, and two knuckles 826, 827 are positioned on the cover 812, opposite the planar pad surface 820. The knuckles 822, 824 on the body 810 and the knuckles 826, 827 on the cover 812 are interleaved such that the knuckles 826, 827 on the cover 812 are received between the knuckles 822, 824 on the body 810. A pin 828 extends through aligned openings in the knuckles 822, 824, 826, 827 and pivotally connects the cover 812 to the body 810, allowing the cover 812 to pivot between the first and second positions. A spring 816 may be disposed between the two knuckles 826, 827 of the cover 812. The spring may be configured to bias the cover 812 toward the first position (see, e.g., FIG. 37). The spring 816 may be a torsion spring, with one leg resting against the body 810 and the other leg resting against a portion (e.g., a knuckle) of the cover 812. In some implementations, the hinge 814 may include a detent configured to releasably secure the cover 812 in the second position, while permitting the cover 812 to be moved out of the second position in response to an applied force.

The foregoing description of the present disclosure is intended to be illustrative; it is not intended to be exhaustive or to limit the claims to the precise forms disclosed. Those skilled in the relevant art can appreciate that many modifications and variations are possible in light of the foregoing description and associated drawings.

Reference throughout this specification to an “embodiment,” “implementation,” or words of similar import indicates that a particular described feature, structure, or characteristic is included in at least one embodiment of the present disclosure. Thus, the phrase “in some implementations,” or a phrase of similar import, as used throughout this specification, does not necessarily refer to the same embodiment.

The described features, structures, or characteristics may be combined in any suitable manner in one or more embodiments. In the above description, numerous specific details are provided for a thorough understanding of embodiments of the present disclosure. One skilled in the relevant art will recognize, however, that embodiments of the present disclosure can be practiced without one or more of the specific details, or with other methods, components, materials, etc. In other instances, well-known structures, materials, or operations may not be shown or described in detail.

1. A switch cover assembly comprising:
a body defining an opening that extends between a first end and a second end;
a cover configured to overlie at least a portion of the first end of the opening; and
a hinge configured to pivotally couple the cover to the body such that the cover is movable relative to the body between a first position and a second position;
wherein the opening is configured to provide access to a switch through the first end; and
wherein the cover is configured to inhibit actuation of the switch when in the first position and to permit actuation of the switch when in the second position.

2. The switch cover assembly of claim 1, wherein the second end of the opening is configured for attachment to a flashlight tailcap, the flashlight tailcap including the switch at an end thereof.

3. The switch cover assembly of claim 2, wherein, when in the first position, the cover is configured to be positioned over at least a portion of the switch.

4. The switch cover assembly of claim 1, wherein the hinge includes a spring configured to bias the cover toward the first position.

5. The switch cover assembly of claim 4, wherein the hinge comprises a detent arrangement configured to releasably retain the cover in the second position.

6. The switch cover assembly of claim 5, wherein the detent arrangement comprises a protrusion on the cover and a groove defined by the body, wherein the protrusion is configured to engage the groove when the cover is in the second position.

7. The switch cover assembly of claim 1, wherein the hinge includes a spring configured to bias the cover toward the second position.

8. The switch cover assembly of claim 7, wherein the hinge comprises a detent arrangement configured to releasably retain the cover in the first position.

9. The switch cover assembly of claim 8, wherein the detent arrangement comprises a protrusion on the cover and a groove defined by the body, wherein the protrusion is configured to engage the groove when the cover is in the first position.

10. The switch cover assembly of claim 1, wherein the hinge is a friction hinge configured to resist rotational movement of the cover between the first position and the second position.

11. The switch cover assembly of claim 1, wherein the hinge comprises first and second knuckles on the body, a third knuckle on the cover, and a pin extending through aligned openings in the first, second, and third knuckles.

12. The switch cover assembly of claim 1, wherein the cover includes a planar pad surface.

13. The switch cover assembly of claim 1, wherein the body includes an annular lip configured to receive adhesive thereon.

14. A switch cover assembly comprising:
a body comprising two rail clamps configured for attachment to a rail interface system;
a cover; and
a hinge configured to pivotally couple the cover to the body such that the cover is movable relative to the body between a first position and a second position;
wherein a space configured to receive a switch control module is defined between the two rail clamps of the body; and
wherein the cover is configured to be positioned over at least a portion of the space defined between the two rail clamps of the body.

15. The switch cover assembly of claim 14, wherein, when the switch control module is received in the space, the cover is configured to inhibit actuation of a switch of the switch control module when in the first position and to permit actuation of the switch when in the second position.

16. The switch cover assembly of claim 14, wherein the hinge includes a spring configured to bias the cover toward the first position.

17. The switch cover assembly of claim 16, wherein the hinge comprises a detent arrangement configured to releasably retain the cover in the second position.

18. The switch cover assembly of claim 17, wherein the detent arrangement comprises a protrusion on the cover and a groove defined by the body, wherein the protrusion is configured to engage the groove when the cover is in the second position.

19. The switch cover assembly of claim 14, wherein the hinge includes a spring configured to bias the cover toward the second position.

20. The switch cover assembly of claim 19, wherein the hinge comprises a detent arrangement configured to releasably retain the cover in the first position.

21. The switch cover assembly of claim 20, wherein the detent arrangement comprises a protrusion on the cover and a groove defined by the body, wherein the protrusion is configured to engage the groove when the cover is in the first position.

22. The switch cover assembly of claim 14, wherein the hinge is a friction hinge configured to resist rotational movement of the cover between the first position and the second position.

23. The switch cover assembly of claim 14, wherein the hinge is a barrel-type hinge.

24. The switch cover assembly of claim 14, wherein the cover includes a planar pad surface at one end of the cover.

25. A switch cover assembly for a remote switch, the switch cover assembly comprising:
a body configured for attachment to a rail interface system;
a cover; and
a hinge configured to pivotally couple the cover to the body such that the cover is movable relative to the body between a first position and a second position;
wherein the body is configured to be positioned adjacent to the remote switch; and
wherein the cover is configured to inhibit actuation of a switch of the remote switch when in the first position and to permit actuation of the switch when in the second position.

26. The switch cover assembly of claim 25, wherein the cover is configured to be positioned over at least a portion of the switch when in the first position.

27. The switch cover assembly of claim 25, wherein the hinge includes a spring configured to bias the cover toward the first position.

28. The switch cover assembly of claim 27, wherein the hinge comprises a detent arrangement configured to releasably retain the cover in the second position.

29. The switch cover assembly of claim 28, wherein the detent arrangement comprises a protrusion on the cover and a groove defined by the body, wherein the protrusion is configured to engage the groove when the cover is in the second position.

30. The switch cover assembly of claim 25, wherein the hinge includes a spring configured to bias the cover toward the second position.

31. The switch cover assembly of claim 30, wherein the hinge comprises a detent arrangement configured to releasably retain the cover in the first position.

32. The switch cover assembly of claim 31, wherein the detent arrangement comprises a protrusion on the cover and a groove defined by the body, wherein the protrusion is configured to engage the groove when the cover is in the first position.

33. The switch cover assembly of claim 25, wherein the hinge is a friction hinge configured to resist rotational movement of the cover between the first position and the second position.

34. The switch cover assembly of claim 25, wherein the hinge is a barrel-type hinge.

35. The switch cover assembly of claim 25, wherein the cover includes a planar pad surface at one end of the cover.
